(19) United States
(12) Patent Application Publication
(10) Pub. No.: US 2015/0325391 A1
(43) Pub. Date: Nov. 12, 2015

(54) BACKLIT ILLUMINATED KEYBOARD FOR EDITING PURPOSES

(71) Applicant: Mark B. Brown, Manchester (GB)

(72) Inventor: Mark B. Brown, Manchester (GB)

(21) Appl. No.: 14/484,308

(22) Filed: Sep. 12, 2014

(30) Foreign Application Priority Data
May 7, 2014 (GB) GB1408041.0

(51) Int. Cl. H01H 13/83

(52) U.S. Cl. CPC H01H 13/83

(57) ABSTRACT

Disclosed illuminated keyboard specifically useful for video editing, audio editing and design programs running on a computer device comprises a plurality of keys provided with a standard keyboard letter, a shortcut key and at least one text describing the least one action to be preformed using the computer device. The illuminated keyboard includes at least one backlit means activated using a button on the illuminated keyboard for illuminating the plurality of keys under low light conditions. The shortcut key on the plurality of keys of the illuminated keyboard is an icon and/or a diagram or an image to easily describe the at least one action to be preformed using at least one program. The plurality of keys of the illuminated keyboard has different colors to enable the users to easily read the standard keyboard letters, icons and the at least one text on the plurality of keys.

### CROSS-REFERENCE TO RELATED APPLICATION

This application claims benefit of priority of UK Patent Application Serial Number GB1408041.0, filed May 7, 2014, entitled “BACKLIT ILLUMINATED KEYBOARD FOR EDITING PURPOSES”, owned by the assignee of the present application and herein incorporated by reference in its entirety.

### BACKGROUND

The present invention relates to a backlit-illuminated keyboard. More particularly, the present invention relates to a backlit-illuminated keyboard having colored keys for use in editing and design purposes.

Keyboards are used with a plurality of computer devices such as personal computers for providing input in form of keystrokes to the devices. There are many styles of keyboards currently available on the market. However most of the exiting keyboards follow the same design and arrangement of letters and symbols on the plurality of keys of the keyboard. The existing keyboards with the same layout of texts and symbols on the pluralities of keys are commonly used for all different types of tasks using the computer device. For example, the keyboard used for text editing and video editing and designing jobs are same. Existing keyboards are particularly oriented for the purpose of text editing. Hence the users of the computer device for other types of jobs such as video editing and designing jobs need to learn all the common shortcuts and keyboard commands to efficiently utilize the computer device. This process is time consuming and erroneous as the user may sometimes forget some shortcuts or may accidentally hit some other keys resulting in an unintended action on the computer device.

Some other existing keyboards cannot be operated under low light conditions as the user may experience difficulty in finding the right keys on the keyboard under the low light situations. This is especially true in case of portable computers such as laptops. These portable computers when used in low light situations resulting in difficulty in seeing the keys of the keyboard. This affects the overall efficiency of the user since it takes more time to identify the keys on the keyboard. To overcome this problem, various types of backlit-illuminated keyboards have been developed. These backlit-illuminated keyboards can effectively be used for typing and other word processing applications. However these backlit-illuminated keyboards still follow the same design and arrangement of letters and symbols on the plurality of keys of the keyboard. Hence the users of the computer device for other types of jobs such as video editing and designing jobs cannot effectively use the backlit-illuminated keyboard and the user need to learn all the common shortcuts and keyboard commands to efficiently utilize the computer device.

Thus, there exists a need for an improved backlit illuminated keyboard that can be used at low light conditions. Persons working on video editing, audio editing and other design jobs would effectively use the needed keyboard. Moreover, the needed keyboard would include shortcuts for video editing, audio editing and other design jobs clearly represented on the keys of the keyboard. Further, the needed keyboard would also be used under low light situations. In addition, the needed keyboard would allow the users to manually turn on and/or off the backlighting on the keyboard. The present invention addresses such a need.

### SUMMARY

The present invention is an illuminated keyboard specifically useful for video editing, audio editing and design programs running on at least one computer device. The illuminated keyboard includes a plurality of keys arranged at specific distances to form a standard keyboard for use with the at least one computer device. The plurality of keys of the illuminated keyboard is provided with a standard keyboard letter, a shortcut key for performing at least one action using the computer device and at least one text describing the least one action to be preformed using the computer device. The illuminated keyboard is specifically designed for use with a plurality of programs such as video editing, audio editing, sound recording, graphic designing and flight simulation programs running on the computer device. The illuminated keyboard includes at least one backlit means for illuminating the plurality of keys. The backlit means is positioned under the plurality of keys to pass the light produced by the backlit means through the plurality of keys from a bottom portion of each of the plurality of keys. The backlit means enables a user to identify each of the plurality of keys under low light conditions such as when the keyboard is placed in a dark room. The illuminated keyboard further includes at least one button to activate and/or deactivate the at least one backlit means. The user can activate or deactivate the at least one backlit means by pressing the button provided on the illuminated keyboard. The button for controlling the backlit means enables the user to turnoff the backlit means whenever it is not required by the user.

The standard keyboard letter, the shortcut key and the at least one text on the plurality of keys is arranged non-overlapping to each other on the plurality of keys of the illuminated keyboard. The shortcut key on the plurality of keys of the illuminated keyboard is a text, icon and/or a diagram or an image to easily describe the at least one action to be preformed using at least one program such as, but not limited to, the video editing, audio editing, sound recording, graphic designing and/or flight simulation programs running on the computer device. The at least one text on the plurality of keys of the illuminated keyboard describes the least one action to be preformed using the at least one program such as, but not limited to, the video editing, audio editing, sound recording, graphic designing and/or flight simulation programs running on the computer device. The standard keyboard letter, the shortcut key denoting the at least one action to be performed and the at least one text describing the at least one action to be preformed using the computer device on the plurality of keys is made non opaque or semi-transparent to enable light produced by the backlit means to shine through the plurality of keys for displaying the standard keyboard letter, the shortcut key denoting the at least one action to be performed and the at least one text describing the at least one action to be preformed using the computer device in low light situations. This enables the users to easily view each of the plurality of keys and its associated standard keyboard letter, the shortcut key and the at least one text when illuminated using the backlit means. Further, the plurality of keys of the illuminated keyboard have different colors to enable the users to easily read the letters and the icon or diagram on the plurality of keys. The plurality of colored keys enables the users to easily identify keys having similar or associated functionalities while working on the video editing, audio editing, sound recording, graphic designing and/or flight simulation programs running on the computing device.

Other objects and advantages of the embodiments herein will become readily apparent from the following detailed description taken in conjunction with the accompanying drawings.

### BRIEF DESCRIPTIONS OF THE DRAWINGS

FIG. 1 is a perspective view of an illuminated keyboard for use with at least one computer device according to a preferred embodiment of the present invention;

FIG. 2 is a perspective view of the backlit-illuminated keyboard for use with at least one computer device according to a preferred embodiment of the present invention; and

FIG. 3 is a perspective view of the backlit-illuminated keyboard showing an enlarged portion clearly describing a standard keyboard letter, shortcut key and a at least one text on the plurality of keys of the illuminated keyboard according to a preferred embodiment of the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

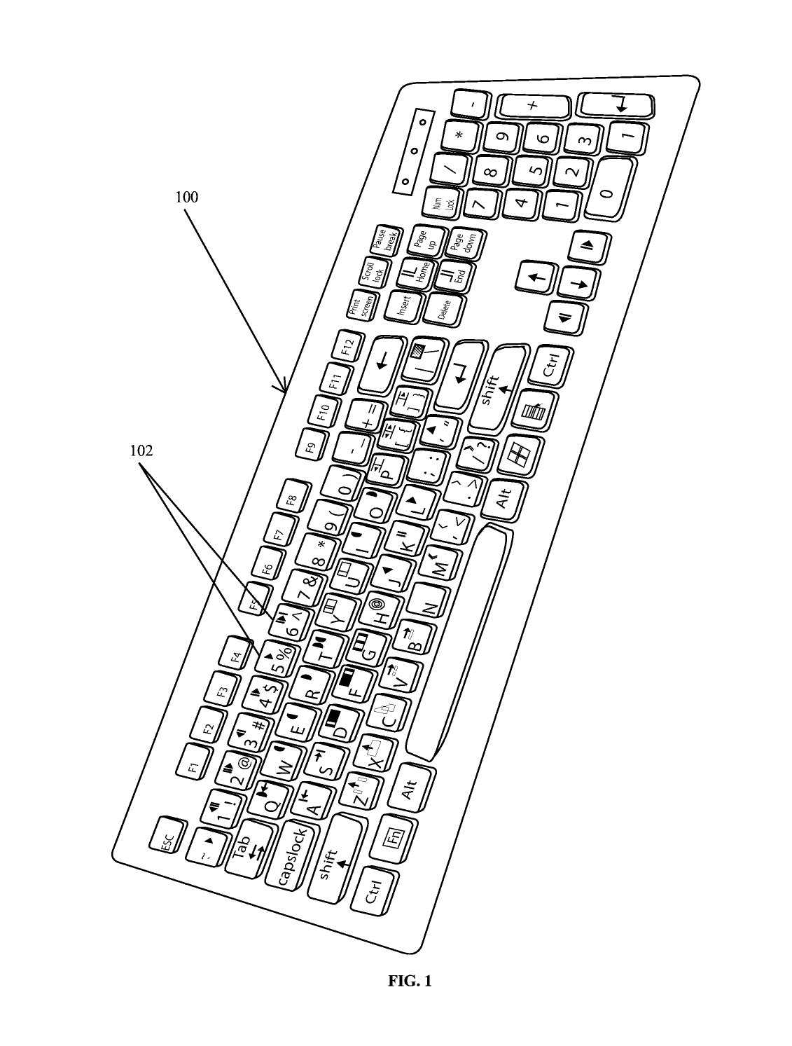

FIG. 1 is a perspective view of an illuminated keyboard 100 for use with at least one computer device according to a preferred embodiment of the present invention. The illuminated keyboard 100 includes a plurality of keys 102 arranged at specific distances to form a standard keyboard for use with the at least one computer device. In a preferred embodiment, most of the plurality of keys 102 of the illuminated keyboard 100 is provided with a standard keyboard letter 104, a shortcut key 106 for performing at least one action using the computer device and at least one text 108 describing the least one action to be preformed using the computer device. The illuminated keyboard 100 of the present invention is specifically designed for use with a plurality of programs such as video editing, audio editing, sound recording, graphic designing and flight simulation programs running on the computer device. The illuminated keyboard 100 includes at least one backlit means for illuminating the plurality of keys 102. The backlit means is positioned under the plurality of keys 102 to pass the light produced by the backlit means through the plurality of keys 102 from a bottom portion of each of the plurality of keys 102. The backlit means enables a user to identify each of the plurality of keys 102 under low light conditions such as when the keyboard is placed in a dark room. The illuminated keyboard 100 further includes at least one button to activate and/or deactivate the at least one backlit means. The user can activate or deactivate the at least one backlit means by pressing the button provided on the illuminated keyboard 100. The button for controlling the backlit means enables the user to turnoff the backlit means whenever it is not required by the user, such as during day times or when the illuminated keyboard 100 is placed under sufficient lighting. Under dark situations, the button can be pressed to enable light to shine through the plurality of keys 102 for displaying the standard keyboard letter 104, the shortcut key 106 for performing at least one action and the at least one text 108 describing the at least one action to be preformed using the computer device in low light situations.

The illuminated keyboard 100 of the preferred embodiment of the present invention includes the plurality of keys 102 arranged similar to the standard keyboard keys such as in the QWERTY mode of arrangement. Moreover, the illuminated keyboard 100 may have a shape and size similar to a standard keyboard and the plurality of keys 102 are arranged, spaced apart, similar to the keys present in the standard keyboard. The standard keyboard letter 104, the shortcut key 106 and the at least one text 108 is arranged non-overlapping to each other on the plurality of keys 102 of the illuminated keyboard 100. The standard keyboard letter 104 on the plurality of keys 102 of the illuminated keyboard 100 is having sufficient size to enable easy viewing by the users. The shortcut key 106 on the plurality of keys 102 of the illuminated keyboard 100 is a text and/or a diagram or an image or icon to easily describe the at least one action to be preformed using at least one program such as, but not limited to, the video editing, audio editing, sound recording, graphic designing and/or flight simulation programs running on the computer device. Similar to the standard keyboard letter 104, the shortcut key 106 on the plurality of keys 102 of the illuminated keyboard 100 is having sufficient size to enable easy viewing by the users. The at least one text 108 on the plurality of keys 102 of the illuminated keyboard 100 describes the least one action to be preformed using the at least one program such as, but not limited to, the video editing, audio editing, sound recording, graphic designing and/or flight simulation programs running on the computer device. The short text description on the at least one text 108 on the plurality of keys 102 of the illuminated keyboard 100 is having sufficient size and a selected font for the text to enable easy viewing by the users. In an embodiment of the present invention, the at least one text 108 on the plurality of keys 102 of the illuminated keyboard 100 is provided in capital letters of sufficient font size for easy viewing by the users. In an embodiment of the present invention, the standard keyboard letter 104, the shortcut key 106 denoting the at least one action to be performed and the at least one text 108 describing the at least one action to be preformed using the computer device on the plurality of keys 102 is made non opaque or semi-transparent. The semi-transparent standard keyboard letter 104, the shortcut key 106 and the at least one text 108 enables light produced by the backlit means to shine through the plurality of keys 102 for displaying the standard keyboard letter 104, the shortcut key 106 denoting the at least one action to be performed and the at least one text 108 describing the at least one action to be preformed using the computer device in low light situations. This enables the users to easily view each of the plurality of keys 102 and its associated standard keyboard letter 104, the shortcut key 106 and the at least one text 108 when illuminated using the backlit means. Thus the users engaged in activities using programs such as, but not limited to, the video editing, audio editing, sound recording, graphic designing and/or flight simulation programs running on the computer device can easily view the plurality of keys 102 and associated standard keyboard letter 104, the shortcut key 106 and the at least one text 108 commonly used for editing and designing purposes under low light conditions. Thereby he/she can continue the process of editing or designing without any interruptions when the light in a room, where the illuminated keyboard 100 and the computer device is placed, becomes suddenly switched off or under low light situations. Under these kinds of situations, the user can just press the button provided on the illuminated keyboard 100, which in turn activates and/or deactivates the at least one backlit means for illuminating the plurality of keys 102.

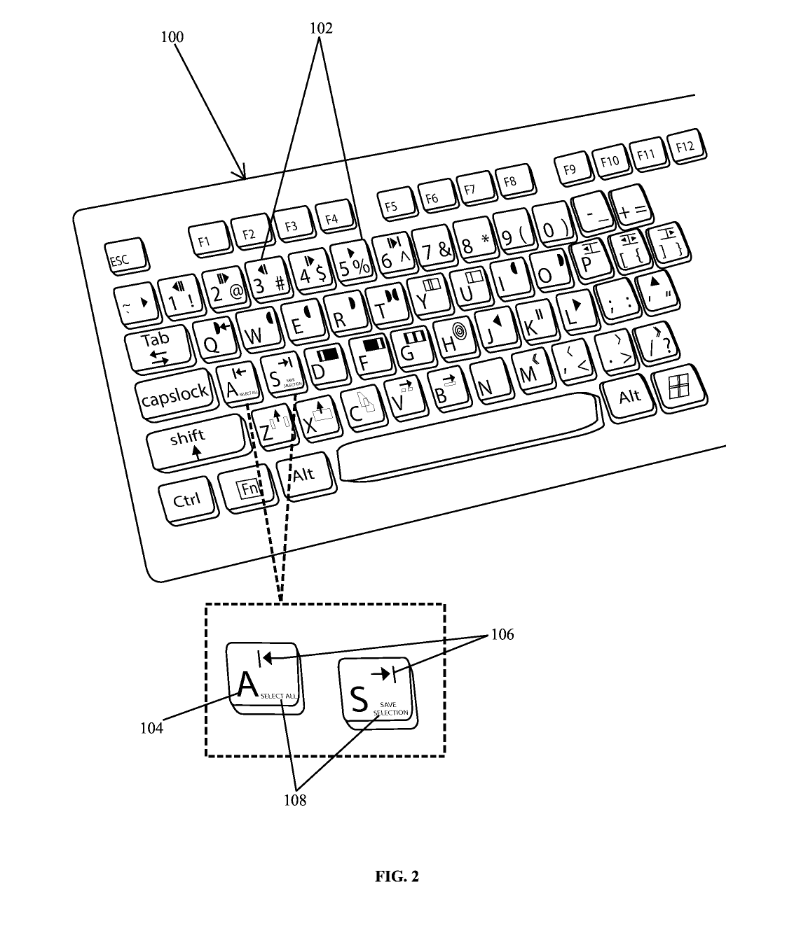

FIG. 2 is a perspective view of the backlit-illuminated keyboard 100 for use with at least one computer device according to a preferred embodiment of the present invention. Pressing the dedicated button provided on the illuminated keyboard 100 activates the backlit means. The light produced by the backlit means shines through the standard keyboard letter 104, the shortcut key 106 denoting the at least one action to be performed and the at least one text 108 describing the at least one action to be preformed using the computer device on the plurality of keys 102. Since the standard keyboard letter 104, the shortcut key 106 denoting the at least one action to be performed and the at least one text 108 describing the at least one action to be preformed using the computer device are provided as semi-transparent, the light shines through it to enable the users to easily view the printing on the plurality of keys 102 under low light conditions. The plurality of keys 102 having the standard keyboard letter 104, shortcut key 106 and the at least one text 108 of the illuminated keyboard 100 is colored using a plurality of colors. Different keys of the plurality of keys 102 having different colors are illuminated using the backlit means. In an embodiment of the present invention, the color of the plurality of keys 102 and the color of the standard keyboard letter 104, shortcut key 106 and the at least one text 108 of the illuminated keyboard 100 are different to enable the user to easily read the letters and the icon or diagram on the plurality of keys 102. In yet another embodiment of the present invention, the color of the standard keyboard letter 104, shortcut key 106 and the at least one text 108 are similar and which is different from the color on the plurality of colored keys 102 of the illuminated keyboard 100. In some other instances of the present invention, the plurality of keys 102 on the illuminated keyboard 100 is selected and grouped based on a plurality of factors such as, but not limited to, its function or use in a particular video editing, audio editing, sound recording, graphic designing and/or flight simulation programs running on the computing device. The plurality of grouped keys 102 having similar or associated functionality is painted with similar colors, which enables the users to easily identify keys 102 having similar or associated functionalities while working on the video editing, audio editing, sound recording, graphic designing and/or flight simulation programs running on the computing device.

The standard keyboard letter 104 on the plurality of keys 102 of the illuminated keyboard 100 is similar to those present in the standard keyboard. The standard keyboard letter 104 on the plurality of keys 102 may be a letter, number, or special symbol. This enables the illuminated keyboard 100 to be used as a normal standard keyboard or input device for performing a plurality of activities by providing a plurality of inputs as keystrokes to the computer device. In some embodiments, the standard keyboard letter 104 portion is illuminated by the backlit means to allow a user to visually identify a particular key in low-light conditions. The shortcut key 106 on the plurality of keys 102 of the illuminate keyboard 100 is usually provided as a line diagram or icon depicting the function of the key 102 such as saving, printing, closing, etc. The preferred embodiment of the present invention provides a plurality of shortcut keys 106 or icons or diagrams on the plurality of keys 102 which is specifically usable with the video editing, audio editing, sound recording, graphic designing and/or flight simulation programs for home and business use running on the computing device to which the illuminated keyboard 100 is connected. The user can view the shortcut key 106 or diagram or the icon to easily understand the function of the particular key 102 in the video editing, audio editing, sound recording, graphic designing and/or flight simulation programs running on the computing device. The at least one text 108 on the plurality of keys 102 describing the functionality of the key 102 makes it even more easier for the user to understand the function of the particular key 102 in the video editing, audio editing, sound recording, graphic designing and/or flight simulation programs running on the computing device. For example, the plurality of keys 102 on the illuminated keyboard 100 includes shortcut key 106 icons of play, replay, stop, forward, backward, skew, rotate, reflect, etc. and with text 108 such as ‘PLAY, ‘REPLAY’, ‘STOP’, ‘FORWARD’, ‘BACKWARD’, ‘SKEW, ‘ROTATE’, ‘REFLECT’, etc. Thus the keys 102 on the illuminated keyboard 100 include shortcuts for video editing, audio editing and other design jobs clearly represented on the plurality of keys 102 of the illuminated keyboard 100. The at least one text 108 on the plurality of keys 102 is a text description or text reference for the shortcut key 106 or diagram or the icon on the plurality of keys 102. With the help of the at least one text 108 and the shortcut key 106 on the plurality of keys 102 any user can identify the shortcut and/or specific functionality of the plurality of keys 102 and its use in the particular video editing, audio editing, sound recording, graphic designing and/or flight simulation programs running on the computing device.

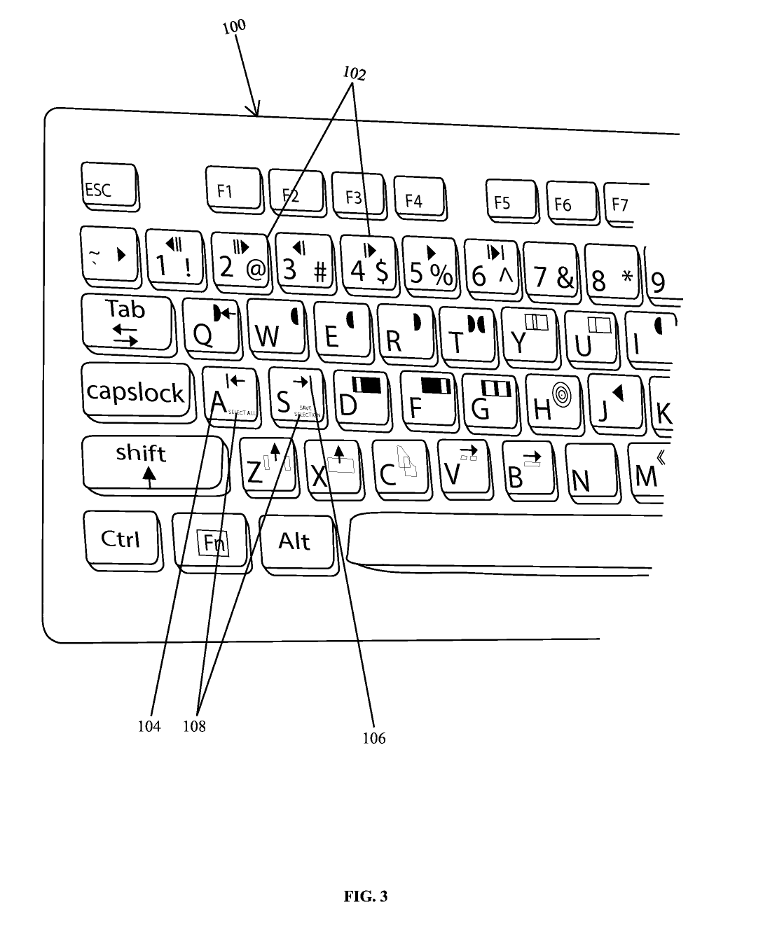

FIG. 3 is a perspective view of the backlit-illuminated keyboard 100 showing an enlarged portion clearly describing the standard keyboard letter 104, shortcut key 106 and the at least one text 108 on the plurality of keys 102 of the illuminated keyboard 100 according to a preferred embodiment of the present invention. From the figure it is clear that the standard keyboard letter 104, shortcut key 106 and the at least one text 108 are arranged non overlapping to each other on the plurality of keys 102 of the illuminated keyboard 100. In an embodiment of the present invention, the standard keyboard letter 104, shortcut key 106 and the at least one text 108 on the plurality of keys 102 is made semi-transparent to pass the light from the backlit means of the illuminated keyboard 100 through it. This makes the standard keyboard letter 104, shortcut key 106 and the at least one text 108 more clearly visible under low light conditions when illuminated by pressing the backlit activating button on the illuminated keyboard 100. In some other embodiments of the present invention, the standard keyboard letter 104, shortcut key 106 and the at least one text 108 on the plurality of keys 102 is made fully transparent thereby making it more visible by passing the light from the backlit means under low light conditions. In yet another embodiment of the present invention, the standard keyboard letter 104, shortcut key 106 and the at least one text 108 on the plurality of keys 102 is made fully opaque and thereby providing maximum visibility under normal light conditions and visible at low light conditions. The light from the backlit means positioned under the keys 102 produces light and is passed through any of the standard keyboard letter 104, shortcut key 106 and the at least one text 108 or passed through all of it and also the light is allowed to escape through the edges of the keys 102. This allows the users to easily distinguish the position of one key 102 on the illuminated keyboard 100 from another key 102 under low light conditions. It is easy for a user to use the illuminated keyboard 100 of the present invention for video editing, audio editing, sound recording, graphic designing and/or flight simulation programs running on the computing device, to which the illuminated keyboard 100 is connected. Since the shortcut key 106 and the at least one text 108 on the plurality of keys 102 clearly describes the functionality of each key 102 for the shortcuts or functions of the video editing, audio editing, sound recording, graphic designing and/or flight simulation programs running on the computing device, the user can maximize his/her productivity and save time by using the illuminated keyboard 100.

In an embodiment of the present invention, the standard keyboard letter 104, shortcut key 106 and the at least one text 108 on the plurality of keys 102 of the illuminated keyboard 100 can be arranged anywhere on the key 102 without overlapping. The computer device may run the plurality of programs including, but not limited to, video editing, audio editing, sound recording, graphic designing and/or flight simulation programs, which allows the shortcuts on the plurality of keys 102 of the illuminated keyboard 100. Hence a user working on any of these programs can effectively employ the illuminated keyboard 100 of the present invention to reduce the time, reduce erroneous hits on keys under low light conditions with the help of the backlit means and the coloring on the keys 102, and thereby can improve the overall efficiency of the user in completing the tasks using the programs running on the computing device. In some other embodiments, the illuminated keyboard 100 may include different colored backlit means for different keys 102 which may be activated by using the dedicated button on the illuminated keyboard 100. The illuminated keyboard 100 is connected to the computing device either through a wired means or using a wireless means of communication, such as Bluetooth, between the illuminated keyboard 100 and the computer device. In yet another embodiment, the illuminated keyboard 100 can form a part of a laptop or a portable compute device for working on the plurality of programs including, but not limited to, video editing, audio editing, sound recording, graphic designing and/or flight simulation programs In some instances, the illuminated keyboard 100 may include the standard keyboard letter 104, shortcut key 106 and the at least one text 108 on the plurality of keys 102 specially designed for use with point of sale (POS) computer devices, where user need to frequently input data under any light conditions without any errors. The computer device may comprise a portable laptop or notebook computer having a display member rotatably coupled to a base member. However, it should be understood that computer device may comprise other types of devices such as, but not limited to, a tablet computer, personal digital assistant, handheld gaming device or other type of portable or non-portable computer device. Further the illuminated keyboard 100 may be integrated into computer device. However, it should be understood that the illuminated keyboard 100 might be configured as a separate and/or discrete component such as a stand-alone keyboard communicating via a wired or wireless connection to another computer device such as a desktop computer.

In some other embodiments of the present invention, the illuminated keyboard 100 includes an ambient light sensor to detect the amount of light in a room or place where the illuminated keyboard 100 is placed for use with video editing, audio editing, sound recording, graphic designing and/or flight simulation programs running on the computer device. The ambient light sensor detects the light level and is used to automatically control the backlit means in the illuminated keyboard 100. Hence this automatically controlled backlit means in the illuminated keyboard 100 eliminates the need for manually actuating the backlit means using the button on the illuminated keyboard 100 and allows worry free and continuous editing/design jobs using the video editing, audio editing, sound recording, graphic designing and/or flight simulation programs running on the computer device. In some instances the backlist means for illuminating the plurality of keys 102 on the illuminated keyboard 100 is one or more light emitting diodes (LED). In some other embodiments, the LEDs used are multicolor LEDs to illuminate the plurality of keys 102 of the illuminated keyboard 100 with different colored lights under different situations. Preferably, the backlist means is configured to facilitate backlighting across the entire width/length of the illuminated keyboard 100. However, it should be understood that the backlist means might be otherwise configured to provide, for example, particular areas of backlighting and/or varied levels of backlight illumination, thereby enabling various different backlit configurations and/or characteristics of the illuminated keyboard 100. In an embodiment, the backlit means is powered using a power supply means such as battery or power supply from the computer device or an external power supply means. In yet another embodiment, the illuminated keyboard 100 having the standard keyboard letter 104, shortcut key 106 and the at least one text 108 on the plurality of keys 102 is backlighted using a plurality of discrete lighting sections. The various lighting sections may provide different functional characteristics such as different color illumination, different intensity of illumination and the like. The various lighting sections may also be used in a fashion allowing certain sections to be independently turned on and off, as needed during low-light use conditions. Thus, embodiments of the present invention provide an illuminated keyboard 100 that is lightweight, generally low cost, easy to assemble, and occupies less space.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

We claim:

1. An illuminated keyboard for providing at least one input to at least one computer device for performing a plurality of tasks using the computer device, the illuminated keyboard comprising:
a plurality of keys arranged at specific distances to form a standard keyboard for use with the at least one computer device, wherein the plurality of keys being provided with a standard keyboard letter, a shortcut key for performing at least one action using the computer device and at least one text describing the least one action to be preformed using the computer device; and
at least one backlit means for illuminating the plurality of keys, wherein the at least one backlit means is activated by pressing a button provided on the illuminated keyboard to enable light to shine through the plurality of keys for displaying the standard keyboard letter, the shortcut key for performing at least one action and the at least one text describing the at least one action to be preformed using the computer device in a plurality of low light situations.

2. The illuminated keyboard of claim 1 wherein the standard keyboard letter, the shortcut key and the at least one text is arranged non-overlapping to each other on the plurality of keys.

3. The illuminated keyboard of claim 1 wherein the standard keyboard letter, the shortcut key and the at least one text on the plurality of keys is made semi-transparent to enable light produced by the backlit means to shine through the plurality of keys for displaying the standard keyboard letter, the shortcut key for performing at least one action and the at least one text describing the at least one action to be preformed using the computer device in low light situations.

4. The illuminated keyboard of claim 1 wherein the button provided on the illuminated keyboard activates and/or deactivates the at least one backlit means for illuminating the plurality of keys to visualize the standard keyboard letter, the shortcut key and the at least one text on the plurality of keys in low light situations.

5. The illuminated keyboard of claim 1 wherein the shortcut key provided on the plurality of keys is selected from a text, icon and/or a diagram to easily describe the at least one action to be preformed using at least one program running on the computer device, wherein the at least one program is selected from a group consisting of a video editing, audio editing, sound recording, graphic designing and flight simulation programs.

6. The illuminated keyboard of claim 1 wherein the at least one text provided on the plurality of keys describes the least one action to be preformed using the at least one program running on the computer device, wherein the at least one program is selected from a group consisting of video editing, audio editing, sound recording, graphic designing and flight simulation programs.

7. The illuminated keyboard of claim 1 wherein the plurality of keys provided with the standard keyboard letter, shortcut key and the at least one text is colored using a plurality of colors.

8. The illuminated keyboard of claim 1 wherein the plurality of colors on the plurality of keys illuminated using the at least one backlit means enables a user to identify each key under low light situations, wherein the plurality of colors on the plurality of keys groups a plurality of keys based on a function of the key on the video editing, audio editing, sound recording, graphic designing and flight simulation programs running in the computer device.

9. The illuminated keyboard of claim 1 wherein the plurality of keys includes an opaque colored portion and semi-transparent standard keyboard letter, the shortcut key and the at least one text describing the at least one action to be preformed using the video editing, audio editing, sound recording, graphic designing and flight simulation programs running in the computer device.

10. The illuminated keyboard of claim 9 wherein the semi-transparent standard keyboard letter, shortcut key and the at least one text allows light from the backlit means to shine through when illuminated using the at least one backlit means.
